(19) United States
(12) Patent Application Publication
(10) Pub. No.: US 2009/0200812 A1
(43) Pub. Date: Aug. 13, 2009

(54) BAT SCOOPER

(76) Inventor: NELSON MAMBRU, Orlando, FL (US)

Correspondence Address: NELSON MAMBRU, 11944 DELFINA LANE, ORLANDO, FL, 32827, US

(21) Appl. No.: 12/364,467

(22) Filed: Feb. 2, 2009

Related U.S. Application Data
(60) Provisional application No. 61/028,299, filed on Feb. 13, 2008.

(51) Int. Cl. A01K 29/00

(52) U.S. Cl. 294/1.4

(57) ABSTRACT

Bat Scooper is an upright self-standing one-hand operated pet waste retrieving device comprising a surrounding frame spider grapple mechanism which includes a plurality of fingers a round support frame and an outside O ring operator. The device is encased on a bat-like frame with wider lower chamber ending on an open circular base. An auto-locking control assembly locks in close position an otherwise open spider grapple and the grapple remains in this position until released by release button atop the device. The apparatus is equipped with a snap-on liner for easy, sanitary use.

### CROSS-REFERENCE TO RELATED APPLICATION

This application claims the benefits of U.S. Provisional Patent Application Ser. No. 61/028,299, filed Feb. 13, 2008.

### STATEMENT REGARDING FEDERALLY SPONSORED RESEARCH OR DEVELOPMENT

Not Applicable

### BACKGROUND OF THE INVENTION

1. Field of the Invention

The Present invention relates to hand-operated, pole mounted grasping devices. In particular this invention relates to sanitary handlers of animal waste of the kind commonly known as pooper scoopers.

2. Description of Related Art

Pole-mounted hand-operated grasping or scooping devices for the collection of animal waste have been around for a long time and are well known. These devices assist users with the collection of pet waste by minimizing excessive bending and keeping the user from coming in direct contact with the object been collected. Some require the use of both hands to be operated while others offer the benefits of one hand operation. There are pet waste retrieving devices available in the market designed to hold a bag to keep the device clean after use. Without a proper wash or equivalent cleaning, devices lacking such barrier become soiled after use and can become unsanitary and unattractive for home storage.

U.S. Pat. No. 4,058,337 issued to Mircea Isac November 1977 describes an apparatus for the collection of dog feces with the general appearance of a walking cane and having a disposable container.

U.S. Pat. No. 5,564,763 issued to Cindy P. Mecurio October 1996 depicts a device for removing dog droppings. This device includes a pair of clamshell shaped membranes having interlocking elongated fingers. This apparatus is not a pole-mounted device forcing the user to bend down at time of waste collection from the ground.

U.S. Pat. No. 5,601,321 describes an apparatus for dog waste retrieval having opposing jaws joined by a pivot point. This device contains major moving parts exposed to the elements.

U.S. Pat. No. 2006/0214440A1 issued to Michael John Thomann describes a device for the collection of pet waste with a bat-like appearance. According to its description this device requires the use of both hands for collection.

The complexity of sanitary pet waste collection is significant and even with the diverse assortment of pooper scoopers being marketed today it is not uncommon to see dog walkers bending down and putting their hands into used grocery bags to collect dog waste even as they come in close contact with dog feces. This behavior, while noble reveals that there is still a need for an effective, reliable dog waste collection device to assist dog walkers. The intention of the invention next described is to provide such a device.

### SUMMARY OF THE PRESENT INVENTION

The main object of the present invention is to provide a reliable dog waste collection device that eliminates excessive bending, keeps the user's hands from coming in direct contact with dog feces and that it is easy to use.

It is another object of this invention to produce an apparatus for dog waste collection with no exposed major mechanical moving parts allowing it to be more durable and reliable; it is yet another object of this invention to provide a pooper scooper that is light weight and easy to carry.

The effectiveness of fingers and the like to grasp and secure objects especially from uneven surfaces has proven to be a reliable method for collection. It is the object of this invention to capture in some form the essence of hand dog waste collection by incorporating fingers into the collection device.

Bat Scooper is an upright, self-standing one-hand operated dog waste retrieving device with a spider grapple means having a plurality of flexible fingers. The device is encased on a bat-like frame to assist the user from coming into close contact with dog feces and eliminating the need for excessive bending at time of collection. Further, this apparatus can be used with a snap-on bag for easy, sanitary waste collection.

The snap-on bag serves as a liner rather than a container to bag dog waste because it does not have to come off the device when emptying the same. This feature allows for multiple collections with the same liner when multiple droppings are scattered over an area.

The Bat Scooper works well on grass, cement, asphalt, snow or sandy surfaces.

In preparation to use the device, the dog walker snaps on the custom fitted liner onto the bottom of the device preferably before he commences his walk.

To collect the waste the user places the wide, flat open base of the Bat Scooper over of the feces, covering its totality and surrounding the same with the liner-protected spider grapple. With one swift movement the user pushes down on the device handle. This action causes the spider grapple to close trapping the waste inside the device.

The device handle down displacement can be of one inch or less according the present invention; at the end of which, the auto-locking means is activated locking the device into close position securing the waste inside the device. The same action compresses the main spring and activates the release button.

To discharge the device, the user presses down on the release button atop of the Bat Scooper. This action causes the auto-locking means to deactivate allowing the spider grapple to come back to its open rest position with the assistance of the main spring. The content of the device is then free to fall by gravity and the liner remains secured in place.

If more than one collection is required in the same general area and time, pressing the release button while the device is atop the new waste being collected will open the device enabling the user to collect additional droppings in the aforementioned manner.

To clean the device at the end of the walk or after finding a trash container, the user may press the release button and pull off the custom fitted liner by pulling its tab to detach it from the device and to dispose of it as trash. The apparatus remains clean and ready for use.

### BRIEF DESCRIPTION OF THE DRAWINGS

The foregoing and other features of the present invention will be more readily apparent from the following detailed description of preferred embodiments taken in conjunction with the attached drawings wherein:

FIG. 1 is a perspective view of the waste retrieval device according to the present invention;

FIG. 2 is a set of views of the spider grapple means of the waste retrieval device according to the present invention;

FIG. 3 is a set of detailed components of the waste retrieval device according to the present invention;

FIG. 4 is a flat view of the liner for the waste retrieval device according to the present invention;

FIG. 5 is the exploded view of the waste retrieval device according to the present invention.

### DETAILED DESCRIPTION OF THE PREFERRED EMBODIMENTS

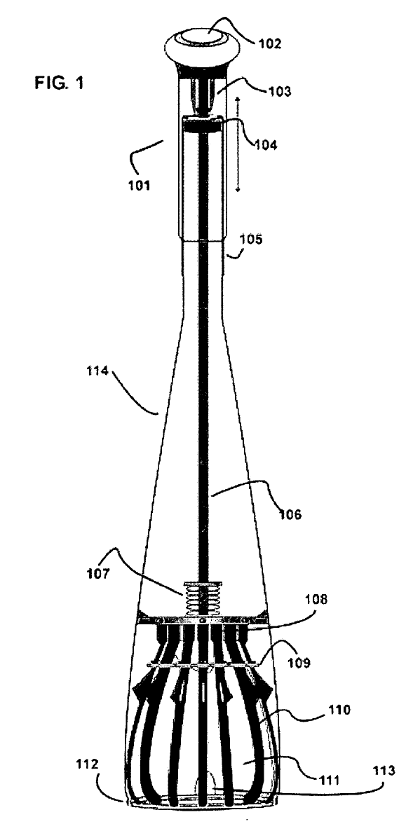

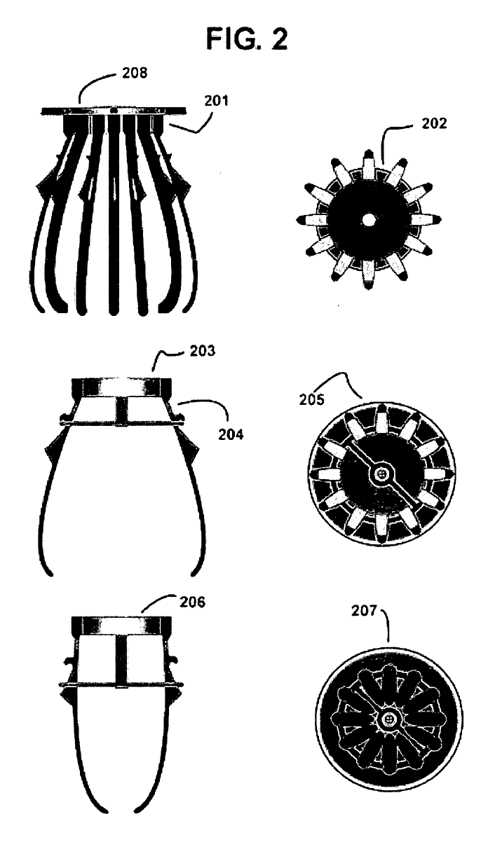

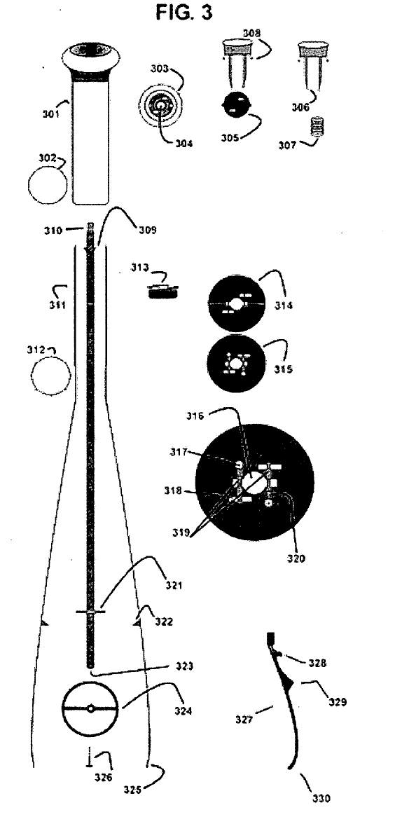

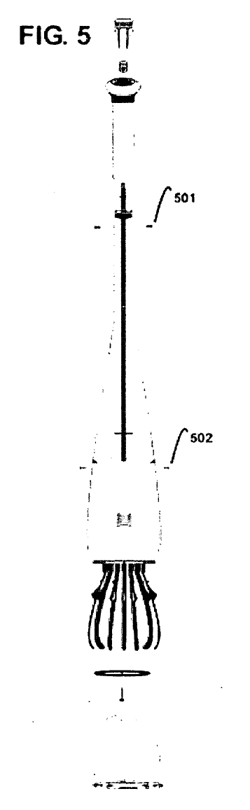

Like numerals are to represent like components through the description referring to FIG. 1 through 5 and their components of the preferred embodiment of the present invention. FIG. 2 and FIG. 3 contain detailed components as well as alternative views of some key components. In addition, all component references contained herein are numbered with a three digits system with the first digit of every component pointing to the figure in which the component is found; in this fashion, element 207 will referrer to the same element found on FIG. 2 and so forth.

The description contained herein is exemplary in nature and is in no way intended to limit the material selection, practical use, size, or application of the present invention. Other shapes capable of housing a self-standing pole-mounted spider grapple means and covered by the scope of the claims of this invention should be perceived as contained within the present description.

Referring to the drawings in detail in FIG. 1 through 5 the invention descried herein has an elongated self-standing bat-like frame made of hard plastic composite, light weight metal such as aluminum or another suitable material. It has a hollow interior, movable handle 101 and the bottom of the device ends on a flat open base 112. The top most portion of the device handle contains the release button 102. The interior proximal houses the auto-locking means 104. The distal interior chamber contains the spider grapple means 108. The flat base 112 of the apparatus allows it to stand in the upright position and ends on a round outwardly curling bevel which serves as the receiving rim 325 for the coupling of the custom fitted liner 111. A tab 113 on the custom fitted liner 111 facilitates its prompt easy removal of for disposal.

The inner shaft 106 is made of hard plastic or light weight metal; is a long cylindrical solid rod with one end having a spiral male screw head 310 with opposing end 323 ending flat and having at least one small female screw fitting. Inner shaft 106 fastens together the apparatus main frame 114 with the device handle 101 and commands down or up movement of O ring sliding operator 109.

The O ring sliding operator 109 compresses the plurality of fingers 110 composing the spider grapple 108 to close it as it travels downwards. As the O ring 109 returns to the up rest position it allows the spider grapple 108 to return to its open rest position.

Inner shaft 106 down displacement compresses the main spring 107 which stores the energy necessary to allow the inner shaft 106 to return to its original rest position after being properly released.

Down displacement and concurrent up return of the device handle 101, need to be no more than one inch in length each way to accomplish its function according to the present invention.

At neck level the inner shaft 106 has two opposing triangular protrusions 309 herein named the V neck. The V neck 309 dimensions are reciprocal with the auto-locking control means 104 and activate the same as the V neck 309 passes through the auto-locking control means center hole 316 by displacing the set of traps 319. Wherein the crescent slope of the V neck 309 ends abruptly and allows the traps 319 to return to their inner rest position thereby locking in down position the inner shaft 106. The inner shaft 106 remains in this state until traps 319 are displaced by the releasing fangs 103 at the posterior end of the release button 102. A solid, shaft-centered disk 321 at the lower section of the inner shaft 106 serves as retainer for the main spring 107.

The device movable handle 101 is made from the same material as the main body 114 of the device and is a tubular member with hollow posterior end, bat-head-like superior end with at least portion of its top center cutout and hollow and made to couple the release button 102. The interior center of handle's head contains a female screw fitting 304 to mate the inner shaft superior end 310. It has two transversal pass-through holes for the release button protruding fangs 103 and two lateral opposing holes to engage the release button supporting flaps 308. The hollow interior camber of the release button retains the release button spring 307. The lower inner walls of device handle contains guiding grooves 302 to mate guiding ribs 105 on the superior end of main body to guide and keep the handle 101 from rotating in relation to the body 114 of the device as the handle 101 travels up or down. Said guiding grooves 302 commence internally just below the member's head and extend thereafter to the handle's posterior end. Wherein the guiding ribs 105 on the main body 114 extend just pass the length of guiding grooves.

A wrist strap (not shown) may be attached to the upper portion of the device handle 101 just below the neck to facilitate easy carry.

The spider grapple means 108 consists of a plurality of fingers 110, a circular frame 208 and O ring outside sliding operator 109. Said spider grapple 108 is supported in the main body 114 by eight flat head screws 502 and interior supporting lip 322. Alternately, support means for the spider grapple 108 in the form of interlocking lips may be molded onto the main body's lower inner chamber eliminating the need for screws to support spider grapple 108. The spider grapple circular frame 208 consist of two dissimilar in size circular members sandwiched together and which are perforated by a common center hole wherein the superior circular members is made to fit supporting means on main body's lower inner chamber. And inferior circular member 201 is made to support a plurality of fingers.

Fingers 110 on the spider grapple 108 are flat, slender, elongated, bow shaped 327 with superior end or head made to mate supporting frame inferior circular member 201, at neck level 204, fingers are flexible allowing pivoted lateral movement with minimum stress. A down oriented claw-like protrusion 328 just below the finger's flexible neck 204 serves as retainer for O ring outside sliding operator 109. Below the claw-like protrusion 328, another protrusion in the shape of a triangle 329 and referred through this description as the shark fin 329, serves as sliding plane for O ring sliding operator 109 and produces angle deflection; the increased angle deflection maximizes finger's inward lateral movement and minimizes required O ring sliding operator 109 downward movement. The finger posterior end 330 terminates on a smooth rounding end with raised, slightly scooping bevel.

The O ring outside sliding operator 109 is an O shaped smooth strong member with transversal union and having a center hole with said hole made to mate supporting means at lower end of inner shaft 106. Said O ring sliding operator 109 aided by main spring 107 slightly pulls finger's claw-like protrusions 328 up on rest position thereby assisting spider grapple 108 open position and adding sturdiness to whole device. The O ring sliding operator 109 down displacement forces the otherwise open spider grapple 108 to close by forcing its fingers 110 inwardly to a center point. The spider grapple circular support frame 208 and fingers 110 can be molded as a single component made of plastic or light suitable metal. Alternately, the support frame 208 and fingers 110 can be two different elements joined by supporting means as deem necessary.

When assembling the spider grapple mechanism 108, the O ring outside sliding operator 109 is put in place by manually contracting the spider's fingers 110 to close the grapple and pushing the O ring 109 from the bottom up over the fingers 110; the O ring 109 has to rest on the outside of the spider grapple between the fingers claw-like protrusions 328 and the finger's shark fins 329. The O ring 109 may be attached to the inner shaft 106 by screwing the long screw 326 to the inner shaft's female screw fitting at the lower end 323 of inner shaft 106.

The auto-locking means 104 comprises a circular member wherein a circular and rectangular shape are superimposed to form a center hole 316 and having two additional transversal lateral pass-through holes 318. On its posterior end the circular member supports two pivoted rods 319 alternately named herein pivoted traps which are assisted by torsion springs 320. Down displacement through pass-through holes 318 of protruding long fangs 103 at posterior end of release button 102 command the pivoted traps 319 away from center rest position thereby releasing inner shaft 106 and its consequential up return aided by main spring 107. The auto-locking means 104 is made to fit atop of the main body 114 and may be supported by three flat head screws 501 or by a spiral lip screw or another method as deem necessary.

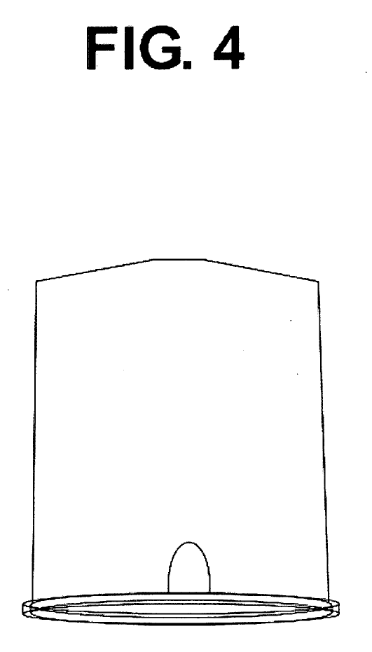

FIG. 4 presents a disposable liner; it is a snap-on disposable liner made for the apparatus comprising a sturdy circular frame with hollow center. With said frame having a cross-sectional L shape, a pull tab 113 protruding from the liner's frame and smooth thin plastic 111. Wherein the frame inner sidewalls have a surrounding lip to mate the liner support rim 325 of apparatus and liner's thin smooth plastic portion 111 is affixed to the frame's lower walls. The disposable liner member can be compared to a butter tub lid which center has been removed and smooth thin plastic or like material has been affixed to its lower inner walls.

The disposable liner, remains attached to the device liner support rim 325 after device auto-locking means 104 has been released. Pulling the liner's tab 113 detaches said liner from main device.

In preparation to use the device the user may load the liner on the liner support rim 325 at the base of the device 112 by snapping the liner into place preferably before he commences the dog walk. The liner snaps to the liner support rim 325 in a fashion comparable to that of capping a butter container. Pushing in the loose part of the liner 111 into the spider grapple 108 with hand or other object will ensure the base of the device remains open and the grapple's readiness for sanitary collection.

To use the apparatus, the user puts the device on top of the waste to be collected ensuring to cover its totality. In that position, the base of the device 112 comes in contact with the ground or other surface of collection and the spider grapple 108 surrounds the waste. A swift down movement of device handle 101 forces the spider grapple 108 to close. The spider grapple opening goes from a five inches wide diameter, in a medium size scooper as described herein, to a less than one inch diameter opening trapping the waste inside the base of the device. Aided by the auto-locking means 104, the spider grapple 108 will remain closed until the release button 102 is pressed.

The open spider grapple aided by gravity allows waste to free fall to discharge the apparatus.

Referring to FIG. 2 a set of different views of the spider grapple means according the present invention is provided; component 202 is the spider grapple means seen from the bottom up. Component 205 is the spider grapple means bottom view as seen in place inside the apparatus in its open position. Component 207 is the spider grapple means bottom view as seen in place inside the apparatus in its close position.

Component 203 is a cross-sectional view of the spider grapple without upper portion of supporting circular frame wherein the grapple stands its open position; inner shaft and O ring sliding operator are up. Component 206 is a cross-sectional view of the spider grapple without upper portion of supporting circular frame wherein the grapple stands its close position; inner shaft and O ring are down.

Referring to FIG. 3 perspective view of some components are contained herein according to the present invention. Component 301 is a lateral view of apparatus handle 101 without release button. Component 303 is a top view of apparatus' handle 101 exposing its inner holes. Component 305 is a bottom view of release button showing preferred long fangs 103 orientation. Component 306 is a side view of release button 101 highlighting long fangs sharp ends orientation. Component 311 shows main body's guiding ribs 105 at preferred length. Component 312 is a cross-sectional view of top main body end showing a plurality of spaced guiding ribs 105. Component 313 is a side view of auto-locking means 104 according to present invention. Component 314 is a top view of auto-locking means 104. Component 315 is bottom view of auto-locking means 104. Component 317 shows screw supporting pivoted traps 319. Component 324 is a flat view of O ring sliding operator 109 showing its transversal union and center hole.

What is claimed is:

1. A pet feces retrieval device comprising:
an upright self-standing elongated tubular frame with bottom ending on an open circular rimed base, with said base being proportionally wider than top opposite end, with said rim shaped to support a custom fitted snap-on disposable liner and further comprising:
an auto-locking control means, a hollow lower inner chamber with grapple supporting means, wherein a grapple means composed of a plurality of fingers connected to a circular frame and controlled by sliding operator is contained,
wherein device handle down displacement results in otherwise open grapple means to close,
a movable handle containing auto-locking control releasing means, and
wherein an inner shaft fastens together said apparatus handle with main tubular frame.

2. A pet waste retrieving device as claim 1, wherein said fingers comprising grapple means are flat slender elongated bow shaped with superior end mating supporting means on circular frame of grapple and at neck level, fingers are flexible allowing pivoted lateral movement and with a down oriented claw-like protrusion just below the finger's flexible neck serving as retainer for O ring sliding operator wherein below the claw-like protrusion another protrusion in the shape of a triangle serves as sliding plane for O ring sliding operator and wherein finger's posterior end terminate on a smooth rounding slightly upwardly raised bevel.

3. A pet waste retrieving device as claim 1 with movable handle comprising a tubular member with hollow posterior end and bat-head-like superior end wherein the interior center of handle contains at least one female screw fitting and the lower inner walls of device handle contain guiding grooves and a release button supports itself atop center of handle and said release button traps in its hollow interior the release button spring.

4. A pet waste retrieving device as claim 1 wherein snap-on disposable liner is made for the device comprising a sturdy circular rim having a cross-sectional L shape, a pull tab protruding from its rim and smooth thin plastic wherein the rim's inner sidewalls have a surrounding lip to mate support rim on main device base and thin smooth plastic portion of liner is affixed to the lower interior walls of circular rim.

5. A pet waste retrieving device as claim 1 wherein grapple circular support frame and fingers can be molded as a single component.
